(19) United States
(12) Patent Application Publication
(10) Pub. No.: US 2023/0029741 A1
(43) Pub. Date: Feb. 2, 2023

(54) Cleaning Mechanism for Optical Tubular Sleeves

(71) Applicant: ATG R&D Limited, Wigan (GB)

(72) Inventors: Richard Joshi, Lowton (GB); George Foster, Whitefield (GB); Thomas Croxson, Wigan (GB)

(73) Assignee: ATG R&D Limited, Wigan (GB)

(21) Appl. No.: 17/782,988

(22) PCT Filed: Dec. 7, 2020
(86) PCT No.: PCT/GB2020/053137

§ 371 Date: Jun. 6, 2022

Related U.S. Application Data
(60) Provisional application No. 62/944,665, filed on Dec. 6, 2019.

(51) Int. Cl. B08B 9/023; C02F 1/32

(52) U.S. Cl. CPC B08B 9/023; C02F 1/325; C02F 2201/324; C02F 2303/20; B08B 2209/02

(57) ABSTRACT

A scraper assembly configured to traverse an exterior surface of a tubular member is disclosed. The scraper assembly includes a casing constructed and arranged to drive the scraper assembly to traverse the exterior surface of the tubular member and a primary ring fixed to the casing, having a plurality of projections formed of a semi-rigid material extending inward toward the exterior surface of the tubular member. A water treatment system including the scraper assembly is also disclosed. A method of retrofitting a water treatment system including providing the scraper assembly is also disclosed. A method of removing organic material fouling from an exterior surface of a quartz sleeve is also disclosed. The method includes directing the scraper assembly to traverse the exterior surface of the quartz sleeve.

### CROSS-REFERENCE TO RELATED APPLICATIONS

This application claims priority under 35 U.S.C. § 119(e) to U.S. Provisional Application Ser. No. 62/794,665, titled “Cleaning Mechanism for Optical Tubular Sleeves” filed Dec. 6, 2019, which is incorporated herein by reference in its entirety for all purposes.

### FIELD OF TECHNOLOGY

Aspects and embodiments disclosed herein are generally related to optical treatment systems, and more specifically, to cleaning assemblies and methods for the optical treatment systems.

### SUMMARY

In accordance with one aspect, there is provided a scraper assembly configured to traverse an exterior surface of a tubular member. The scraper assembly may comprise a casing constructed and arranged to drive the scraper assembly to traverse the exterior surface of the tubular member. The scraper assembly may comprise a primary ring fixed to the casing. The primary ring may have a plurality of projections formed of a semi-rigid material extending inward toward the exterior surface of the tubular member. The plurality of projections may have a length selected to define an inner diameter of the primary ring less than an outer diameter of the tubular member when the plurality of projections are in an extended configuration. The plurality of projections may have a length selected to define a contact angle formed between the plurality of projections and the exterior surface of the tubular member of between about 15° and about 75° when the plurality of projections are in an inclined configuration.

In some embodiments, the scraper assembly may comprise a supplemental ring fixed to the casing having a plurality of projections circumferentially offset from the primary ring.

The scraper assembly may comprise a spacer fixed to the casing positioned between the primary ring and the supplemental ring.

The scraper assembly may comprise a flexible ring fixed to the casing having an inner diameter less than the outer diameter of the tubular member.

The scraper assembly may be configured to traverse the exterior surface of a plurality of tubular members arranged in parallel. The scraper assembly may comprise an array of primary rings. Each primary ring from the array of primary rings may be positioned to traverse the exterior surface of a corresponding tubular member.

In some embodiments, the semi-rigid material may have a yield strength of between about 215 MPa and 290 MPa.

In some embodiments, the semi-rigid material may have a tensile strength of between about 505 MPa and 620 MPa.

The length of the plurality of projections may be selected to define the contact angle based on the yield strength and the tensile strength of the semi-rigid material.

The plurality of projections may each have a thickness of between about 0.1 mm and about 2.0 mm. The thickness of the plurality of projections may be selected based on the yield strength and the tensile strength of the semi-rigid material.

In some embodiments, each of the plurality of projections may make up an arc length of the primary ring of between about 4° and about 30°.

In some embodiments, an interior surface of the plurality of projections has a smaller radius of curvature than a corresponding outer diameter of the primary ring.

In accordance with another aspect, there is provided a water treatment system comprising a vessel having an inlet and an outlet, at least one light source assembly positioned within the vessel, comprising an ultraviolet light housed in a quartz sleeve, and a scraper assembly configured to traverse an exterior surface of the at least one light source assembly. The scraper assembly may comprise a casing constructed and arranged to drive the scraper assembly to traverse the exterior surface of the at least one light source assembly. The scraper assembly may comprise at least one ring fixed to the casing, each ring positioned to traverse the exterior surface of a corresponding light source assembly, each ring having a plurality of projections formed of a semi-rigid material extending inward toward the exterior surface of the corresponding light source assembly, the plurality of projections having a length selected to define an inner diameter of the ring less than an outer diameter of the tubular member when the plurality of projections are in an extended configuration, and a contact angle formed between the plurality of projections and the exterior surface of the corresponding light source assembly of between about 15° and about 75° when the plurality of projections are in an inclined configuration.

The system may further comprise an ultraviolet light sensor positioned to monitor ultraviolet light intensity through the water treatment system.

The system may further comprise a controller operatively connected to the ultraviolet light sensor and the scraper assembly. The controller may be configured to operate the scraper assembly to traverse the exterior surface of the at least one light source assembly responsive to the monitored ultraviolet light intensity being below a threshold value.

The system may comprise a controller operatively connected to the scraper assembly. The controller may be configured to operate the scraper assembly to traverse the exterior surface of the at least one light source assembly responsive to manual actuation or periodically on a pre-determined schedule.

In some embodiments, the semi-rigid material may be selected to be substantially inert to the quartz sleeve and components of the water to be treated.

In some embodiments, the system may further comprise a source of a chemical cleaner fluidly connected to the vessel.

In accordance with another aspect, there is provided a method of retrofitting a water treatment system. The water treatment system may include at least one light source assembly including an ultraviolet light housed in a quartz sleeve. The method may comprise providing a scraper assembly configured to traverse an exterior surface of the at least one light source assembly. The scraper assembly may comprise a casing constructed and arranged to drive the scraper assembly to traverse the exterior surface of the at least one light source assembly and at least one ring fixed to the casing. Each ring may have a plurality of projections formed of a semi-rigid material extending inward toward the exterior surface of the corresponding light source assembly. The plurality of projections may have a length selected to define an inner diameter of the ring less than an outer diameter of the tubular member when the plurality of projections are in an extended configuration. The plurality of projections may have a length selected to define a contact angle formed between the plurality of projections and the exterior surface of the corresponding light source assembly of between about 15° and about 75° when the plurality of projections are in an inclined configuration. The method may comprise providing instructions to install the scraper assembly by the casing to drive the scraper assembly to traverse the exterior surface of the at least one light source assembly.

In some embodiments, the water treatment system includes a track constructed and arranged to guide the scraper assembly by the casing to traverse the exterior surface of the at least one light source assembly. The method may comprise providing the scraper assembly compatible with the track.

In some embodiments, the method may comprise providing instructions to install a track to guide the scraper assembly by the casing to traverse the exterior surface of the at least one light source assembly.

In accordance with yet another aspect, there is provided a method of removing organic material fouling from an exterior surface of a quartz sleeve positioned within a water treatment system comprising an ultraviolet light housed in the quartz sleeve and a scraper assembly configured to traverse the exterior surface of the quartz sleeve. The scraper assembly may comprise a casing constructed and arranged to drive the scraper assembly to traverse the exterior surface of the quartz sleeve and a ring fixed to the casing having a plurality of projections formed of a semi-rigid material extending inward toward the exterior surface of the quartz sleeve. The method may comprise directing the scraper assembly to traverse the exterior surface of the quartz sleeve in a first direction to scrape at least 80% of the organic material fouling from the exterior surface of the quartz sleeve.

In some embodiments, the method may comprise periodically directing the scraper assembly to traverse the exterior surface of the quartz sleeve on a pre-determined schedule. The pre-determined schedule may be every twelve hours or longer.

In some embodiments, the method may further comprise monitoring ultraviolet light intensity through the water treatment system and directing the scraper assembly to traverse the exterior surface of the quartz sleeve responsive to the ultraviolet light intensity being below a threshold value.

The method may further comprise applying a chemical cleaning process before or concurrently while directing the scraper assembly to traverse the exterior surface of the quartz sleeve.

In some embodiments, the organic material fouling may comprise one or more of hardened deposits, sedimentation, oil, grease, and microbiological fouling.

In some embodiments, an amount and/or composition of the organic material fouling is not substantially removable with a rubber scraper.

The method may comprise operating the water treatment system substantially continuously for at least about six months before replacing the scraper assembly or the ring.

The disclosure contemplates all combinations of any one or more of the foregoing aspects and/or embodiments, as well as combinations with any one or more of the embodiments set forth in the detailed description and any examples.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic drawing of a ring deployed on a portion of a tubular member, according to one embodiment;

FIG. 2 is a schematic drawing of a ring, according to one embodiment;

FIG. 3A is a schematic drawing of a cross-sectional view of a ring deployed on a tubular member, according to one embodiment;

FIG. 3B is a diagram showing contact angle;

FIG. 4 is a schematic drawing of a scraper assembly shown in an expanded form on a portion of a tubular member, according to one embodiment;

FIG. 5A is a photograph of an exemplary scraper assembly as shown in FIG. 4, according to one embodiment;

FIG. 5B is an alternate photograph of an exemplary scraper assembly as shown in FIG. 4, according to one embodiment;

FIG. 6A is a schematic drawing of a scraper assembly, according to one embodiment;

FIG. 6B is a cut-away view of the exemplary scraper assembly as shown in FIG. 6A, according to one embodiment;

FIG. 6C is a schematic drawing of a ring configured to be fit onto the exemplary scraper assembly as shown in FIG. 6A, according to one embodiment;

FIG. 6D is a schematic drawing of a flexible ring configured to be fit onto the exemplary scraper assembly as shown in FIG. 6A, according to one embodiment;

FIG. 7 is a schematic drawing of a scraper assembly configured to traverse a plurality of tubular members, according to one embodiment;

FIG. 8A is a schematic drawing of a ring, according to one embodiment;

FIG. 8B is a schematic drawing of a ring, according to one embodiment;

FIG. 8C is a schematic drawing of a ring, according to one embodiment;

FIG. 9A is a photograph of an exemplary ring deployed on a tubular member, according to one embodiment;

FIG. 9B is a photograph of an exemplary ring deployed on a tubular member, according to one embodiment;

FIG. 10 is a box diagram of an exemplary system for water treatment, according to one embodiment;

FIG. 11 is a box diagram of an exemplary system for water treatment, according to one embodiment;

FIG. 12 is a photograph of an exemplary ring on a tapering device, according to one embodiment;

FIG. 13 is a graph of contact angle as a function of projection length;

FIG. 14 is a laser cutting design for an exemplary ring, according to one embodiment;

FIG. 15 is a photograph of a test rig, according to one embodiment;

FIG. 16A is a photograph of test quartz sleeves before removal of sample foulants; according to one embodiment;

FIG. 16B is a photograph of test quartz sleeves after removal of sample foulants, according to one embodiment; and

FIG. 17 is a schematic drawing of a sample ring design, according to one embodiment.

### DETAILED DESCRIPTION

Ultraviolet (UV) light may be used in a purification system to kill or sterilize bacteria and break down contaminants in a fluid, such as water or air. For instance, ultraviolet radiation may convert certain contaminants in water to carbon dioxide and water. As another example the ultraviolet radiation may convert halogenated compounds into halogenated acids.

Ultraviolet light may also be used in photosynthetic reactions to initiate and cause chemical reactions to make chemical compounds. Ultraviolet-light initiated reactions may take place in a gas or liquid phase. Generally, the fluid must be exposed to an effective dose of ultraviolet-light radiation, i.e. a pre-determined minimum intensity for a pre-determined minimum exposure time. The dosage (minimum intensity and exposure time) for a particular process may be determined by routine experimentation and analysis. The dosage for a particular process may be selected based on treatment of a target contaminant, for example, sterilization of a target percentage (e.g., more than 90%, more than 95%, more than 99%, or more than 99.99%) of a target microorganism in the fluid. As a general correlation, a greater intensity of ultraviolet-light radiation may be applied for a shorter exposure time, for a given purification or reaction objective.

An ultraviolet lamp is formed of a hollow conduit of UV transparent material, such as quartz. The hollow conduit may be sealed at both ends, with electrical connections extending through the seals into the conduit. The conduit may be filled with a gas that is known to produce ultraviolet light when excited with a sufficient electrical current. The ultraviolet light is produced when the electrical current passes through the gas in the hollow conduit.

An ultraviolet lamp configured to be immersed in a liquid, such as water, is typically housed in a secondary tube of ultraviolet transparent material. An exemplary suitable ultraviolet transparent material for the tube is quartz. Quartz may be transparent to both ultraviolet and visible light and have some physical properties similar to glass. The UV transparent material housing may have a liquid-tight seal. The housing may be positioned and configured to keep water away from the lamp and its electrical connections.

A system for water treatment may include a tank or other vessel for holding or circulating a fluid to be treated with the ultraviolet radiation source. The ultraviolet lamp housed in the protective tube is typically positioned within the reactor vessel, such that fluid in the vessel is exposed to a sufficient dose of the ultraviolet radiation. Certain systems may contain a plurality of ultraviolet lamps housed in one or more protective tubes. The plurality of lamps may provide a greater dose of ultraviolet radiation. The arrangement may further be employed to facilitate replacement of an ultraviolet lamp within a system. In particular, for a treatment system having a plurality of lamps, one lamp can be isolated and/or replaced without interruption to other lamps.

One problem faced by ultraviolet tubular members is fouling and accumulation of scale (often referred to as “fouling” herein). The contamination is produced by organic and/or inorganic material buildup on the exterior surface of the tubular housing. Fouling and scale tend to accumulate with increased exposure to contaminants, particularly in water treatment systems. Fouling may be influenced by water chemistry (e.g., concentration of organic and inorganic compounds, pH level, redox potential), hydraulics of the fluid (e.g., velocity, shear, eddies), and temperature (e.g., heat from UV illumination). As fouling and scale accumulate on the exterior surface of ultraviolet light assembly, the buildup increasingly blocks ultraviolet light produced by the lamp, reducing intensity and effectiveness of the ultraviolet-light treatment over time. To mitigate or remove fouling and scale, the exterior tubular housing of the ultraviolet light assembly may be be mechanically and/or chemically cleaned.

The systems and methods disclosed herein may be employed for mechanical cleaning of the exterior tubular housing. In certain embodiments, a chemical agent may be used in combination with the mechanical systems and methods disclosed herein.

Another problem faced by ultraviolet light assemblies is inaccessibility within the water treatment system for mechanical cleaning. For instance, ultraviolet light assemblies may be inaccessible without at least partially dismantling the treatment vessel. Single ultraviolet light assemblies within a system having a plurality of ultraviolet light assemblies may be more difficult to access. Thus, cleaning processes to maintain performance of the ultraviolet light assembly may be time consuming and expensive, requiring down time of the water treatment system.

Conventional systems employ a wiper apparatus, generally formed of a soft rubber material, configured to traverse the exterior surface of the ultraviolet light tube wiping off foul and scale. However, the conventional apparatus is not effective at removing certain contaminants. For instance, the conventional rubber apparatus may remove some organic fouling, but tends to leave a smeared residue. Additionally, the conventional rubber apparatus is ineffective against certain inorganic foulants. As a result, systems equipped with conventional rubber apparatuses may require frequent replacement of ultraviolet light assemblies. As previously described, replacement of the UV light assembly may require down time of the system.

Thus, there is a long-felt need for an effective apparatus and method for cleaning the ultraviolet light assemblies of an ultraviolet-light treatment system. The systems and methods disclosed herein are more effective at removing organic and inorganic foulants from the exterior surface of the ultraviolet light assembly, requiring less frequent replacement of the ultraviolet light. In some embodiments, the organic and inorganic foulants may comprise one or more of hardened deposits, sedimentation, oil, grease, and microbiological fouling. The amount and/or composition of the organic or inorganic material foulants removable by the systems and methods disclosed herein is an amount not substantially removable with a conventional rubber scraper. An improved scraper assembly with increased durability, formed of simple materials, showing improved cleaning performance is described herein. The scraper assembly disclosed herein is generally suitable for use in removal of a wider variety of contaminants than conventional designs. For instance, the scraper assembly disclosed herein may more effectively reduce fouling of quartz tubes than conventional designs, increasing performance, lifetime, and efficiency of the ultraviolet treatment system. The scraper assembly disclosed herein may be designed to be suitable for use in water treatment, including disinfection of a water source and reduction of total organic carbon applications.

The scraper assemblies disclosed herein may be used to replace or complement existing conventional devices. In some embodiments, the assemblies may be retrofit to existing water treatment systems.

The scraper assemblies disclosed herein may have an extended lifespan, for example, a lifespan greater than about 6 months, greater than about 9 months, greater than about 12 months, greater than about 15 months, or greater than about 18 months. The lifespan of the scraper assembly may be measured by determining mechanical stability of the device. For example, the device may become spent when one or more portions of the device become mechanically compromised, including by developing visible cracks, chips, or undesired breakage. Some portions of the scraper assembly may be designed to bend. Desired flexibility of the assembly may not generally be a sign of mechanical compromise. However, undesired bending of one or more portions of the scraper assembly may be a sign of mechanical compromise.

The systems and methods disclosed herein may provide the ultraviolet light assembly with an extended lifespan, for example, a lifespan greater than about 6 months, greater than about 9 months, greater than about 12 months, greater than about 15 months, or greater than about 18 months. The lifespan of the ultraviolet light assembly may be measured by determining mechanical stability of the exterior tubular member. For example, the tubular member may become spent when surface damage of the tubular member is sufficient to contribute to accumulation of fouling. In some embodiments, surface damage is a result of increased scraping of the tubular member. In other embodiments, surface damage is caused by constituents of the fluid to be treated. Surface damage may contribute to fouling by providing a textured surface on the tubular member where fouling accumulates.

Additionally, the lifespan of the ultraviolet light assembly or the scraper assembly may be measured by determining efficacy of the ultraviolet radiation treatment of the fluid. Ultraviolet light intensity through the fluid to be treated may be measured. A measured ultraviolet light intensity below a threshold pre-determined value may indicate accumulation of fouling on the exterior surface of the tubular member. The ultraviolet light assembly or the scraper assembly may become spent as the time period between cleaning the exterior surface of the tubular member trends to zero.

Thus, in accordance with one aspect, there is provided a scraper assembly configured to traverse an exterior surface of a tubular member. The scraper assembly may be configured to remove fouling and scale on the tubular member as it traverses the exterior surface thereof. In some embodiments, the scraper assembly may be configured to traverse an exterior surface of an ultraviolet light housing. For example, the scraper assembly may be configured to traverse an exterior surface of a quartz sleeve surrounding an ultraviolet light source.

The scraper assembly may comprise a ring. The ring may be a substantially flat element having an interior circular opening. The exterior profile of the ring may have any required shape. Exemplary rings shown in the figures have a circular exterior profile. However, the exterior profile of the ring may have any other shape and/or may include one or more exterior projections, for example, to provide a fastener hole.

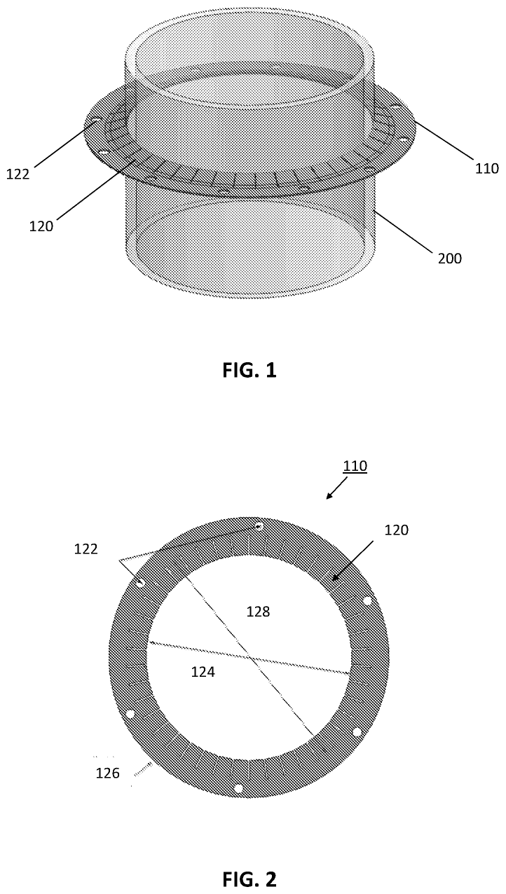

An exemplary ring 110 is shown in FIG. 1. The ring 110 of FIG. 1 is shown deployed on a portion of a tubular member 200. The exemplary ring 110 comprises a plurality of projections 120, discussed in more detail below. The exemplary ring 110 comprises fastener holes 122. The ring 110 may be fastened to the scraper assembly by one or more fastener holes, such as holes 122 in FIG. 1. However, the ring may be fastened to the scraper assembly by other methods, such as gluing (or other adhesive) or welding. The ring may be formed, e.g., molded, with a portion of another assembly element. As shown in FIG. 1, when deployed, the ring 110 may be arranged to surround the tubular member 200, for example, substantially concentrically with the tubular member 200.

The ring 110 may have an outer diameter 126 greater than the outer diameter of the tubular member 200, as shown in FIGS. 1-2. The outer diameter 126 may be selected to fit a desired scraper assembly. The ring 110 may have an inner diameter 124 less than the outer diameter of the tubular member 200, when not deployed on the tubular member 200. In some embodiments, the inner diameter 124 may be about 0.1%, about 0.5%, about 1.0%, about 1.25%, about 1.5%, about 2%, about 3%, about 5%, or about 10% less than the outer diameter of the tubular member 200. The inner diameter 124 may be—about 0.1%-1%, about 0.5%-1.5%, about 1%-2%, about 2%-3%, about 3%-5%, or about 5%-10% less than the outer diameter of the tubular member 200.

The ring may be dimensioned to conform to the exterior surface of the tubular member, when deployed to traverse the surface thereof. Thus, in some embodiments, the ring may be dimensioned to correspond with a target tubular member.

The ring may comprise a plurality of projections extending inward toward the interior opening of the ring. As shown in FIG. 1, the plurality of projections 120 may be configured to extend toward the exterior surface of the tubular member 200, for example, when in use. In some embodiments, the plurality of projections 120 may be formed by radial cuts made outward from the interior opening of the ring 110. The length of the radial cuts may define the length of the plurality of projections 120. The plurality of projections 120 may have a length selected to define the interior diameter 124 of the ring (see also projection length diameter 128) when in an extended configuration. For instance, a greater length of the plurality of projections 120 may produce a ring 110 having a smaller inner diameter 124.

As disclosed herein, the “extended configuration” of the plurality of projections 120 may refer to the configuration in which the plurality of projections 120 are substantially co-planar with the ring 110. The plurality of projections 120 are shown in an extended configuration in FIG. 2. In general, the plurality of projections 120 may be in an extended configuration before the ring 110 has been deployed on the tubular member 200.

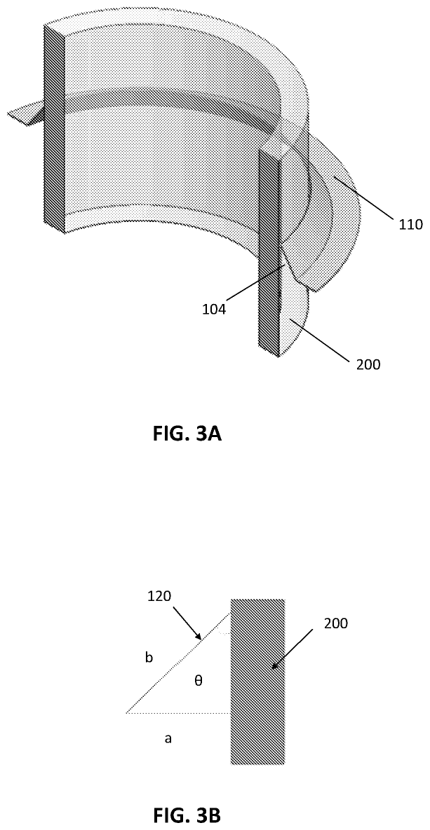

The ring 110 may form a contact angle between an inner edge of the ring 110 and the exterior surface of the tubular member 200. As shown in FIG. 3A, the contact angle 104 is generally formed by deflection when the ring 110 is deployed on the tubular member 200. Upon fitting the ring 110 over the tubular member 200, the ring 110 having a smaller inner diameter 124 than the exterior diameter of the tubular member 200, deflects into a curve against the tubular member 200. The inner edge of the ring 110 may press against the outer edge of the tubular member 200, acting as a scraper against built-up foulants when traversing the surface thereof.

The contact angle 104 may be selected to be between about 10° and about 75°, for example, between about 10° and about 75°, between about 25° and about 65°, between about 30° and about 60°, or between about 40° and about 50°. The contact angle 104 may be selected to be about 10°, about 15°, about 20°, about 25°, about 30°, about 35°, about 40°, about 45°, about 50°, about 55°, about 60°, about 65°, about 70°, or about 75°.

The plurality of projections 120 may be flexible in proportion to their length. The plurality of projections 120 may have a length selected to define the contact angle 104 when in an inclined configuration. For instance, longer projections generally form a shallower contact angle. The relationship between contact angle 104 and length of the plurality of projections 120 is shown in FIG. 3B. As shown in FIG. 3B:

$$θ = {tan}^{- 1} \frac{a}{b}$$

where θ is contact angle;

a is length of the gap between the base of the projections and the tubular member; and

b is length of the projections.

As disclosed herein, the “inclined configuration” of the plurality of projections 120 may refer to the configuration in which the plurality of projections 120 are deflected from the plane of the ring 110. The plurality of projections 120 are shown in an inclined configuration in FIG. 1. In general, the plurality of projections 120 may be in an inclined configuration after the ring 110 has been deployed on the tubular member 200.

Exemplary lengths for the plurality of projections of a scraper assembly configured to fit a conventional ultraviolet light quartz tube include 2.0 mm to 10 mm. For example, the plurality of projections may have a length between about 2.0 mm and about 10 mm, between about 3.0 mm and about 10 mm, between about 4.0 mm and about 10 mm, between about 4.5 mm and about 9.5 mm, between about 5.0 mm and about 9.0 mm, between about 5.5 mm and about 8.5 mm, or between about 6.0 mm and about 8.0 mm. The plurality of projections may have a length of about 2.0 mm, about 2.5 mm, about 3.0 mm, about 3.5 mm, about 4.0 mm, about 4.5 mm, about 5.0 mm, about 5.5 mm, about 6.0 mm, about 6.5 mm, about 7.0 mm, about 7.5 mm, about 8.0 mm, about 8.5 mm, about 9.0 mm, about 9.5 mm, or about 10 mm. Table 1 includes exemplary contact angles formed by projections having exemplary lengths.

TABLE 1
Exemplary Contact Angles

| Length of Projection (b) | | Contact Angle (θ) |
|---|---|---|
| 5.5 | mm | 41° |
| 7.5 | mm | 29° |
| 8.0 | mm | about 25° |
| 10 | mm | about 10° |

The difference between the inner diameter 124 of the ring 110 and the outer diameter of the tubular member 200 may be selected based on physical properties of the ring (e.g., stiffness) and/or physical and chemical properties of the target contaminants to be removed from the exterior surface of the tubular member. In particular, the length of the plurality of projections 120 and the contact angle 104 may be selected based on the properties of the ring and/or the target contaminants. Thus, the ring may be engineered and the properties (e.g., dimensions, stiffness, and thickness) of the ring may be selected based on a target tubular member and/or a target fluid treated by the water treatment system. For instance, the ring may be engineered to reduce structural damage to the tubular member based on a material of the tubular member. The ring may be engineered to have greater stiffness for use on a tubular member employed in a water treatment system configured to treat a fluid with problematic contaminants, such as certain organic and inorganic contaminants that are difficult to remove with flexible scrapers.

The ring and/or the plurality of projections, may be formed of a semi-rigid material. In general, a semi-rigid material may provide mechanical advantages to the cleaning mechanism, as compared to conventional flexible material wipers. For instance, the semi-rigid material may provide improved removal of problematic organic and inorganic foulant materials, such as oily and greasy contaminants and hardened deposits.

The semi-rigid material may be selected to have a desired yield strength and/or tensile strength. The yield strength of a material is the stress corresponding to the yield point of the material. When greater stress is applied to the material, plastic deformation may occur (some percent of the deformation may be permanent and non-reversible). Thus, the yield point generally indicates the limit of elastic behavior of the material. The tensile strength of a material is the stress the material can withstand without breakage. When greater stress is applied to the material, breakage may occur.

The semi-rigid material may be selected to have a yield strength that corresponds with an irreversible deflection of the plurality of projections in the incline configuration. The yield strength may be selected based on thickness of the material. In some embodiments, the semi-rigid material may have a yield strength of between about 200 MPa and about 300 MPa. For example, the semi-rigid material may have a yield strength between about 215 MPa and about 290 MPa. The semi-rigid material may have a yield strength of about 215 MPa, about 275 MPa, or about 290 MPa.

The semi-rigid material may be selected to have a tensile strength that corresponds with sufficient removal of problematic contaminants from the tubular member, without overly compromising (e.g., causing breakage that affects performance) the material of the ring. The tensile strength may be selected based on thickness of the material. In some embodiments, the semi-rigid material may have a tensile strength of between about 500 MPa and about 650 MPa. For example, the semi-rigid material may have a tensile strength of between about 505 MPa and about 620 MPa. The semi-rigid material may have a tensile strength of about 505 MPa, about 580 MPa, or about 620 MPa.

Exemplary semi-rigid materials that may be used to form the ring and/or the plurality of projections include spring steels, such as 312 stainless steel, 302 stainless steel, 304 stainless steel, and 316 stainless steel. Other materials having the selected yield strength and tensile strength are within the scope of the disclosure. For example, the ring and/or plurality of projections may comprise other spring steels, stainless steels, natural polymers, synthetic polymers, or combinations thereof.

In some embodiments, the plurality of projections may comprise a polymer portion. For example, the interior surface of the plurality of projections may be formed of a polymer material. In some embodiments, the plurality of projections may be at least partially coated in the polymer material. The interior surface of the plurality of projections may be coated in the polymer material. Exemplary polymer materials include acrylate polymers such as poly(methyl methacrylate), fluoropolymers such as polytetrafluoroethylene (PTFE), polysiloxane, and other polymer materials having a smooth exterior surface.

In some embodiments, the semi-rigid material of the ring may be treated to improve tensile strength in areas of deflection of the plurality of projections. The treatment may comprise, for example, heat treatment and/or annealing. The treatment may be effective to reduce the incidence of breakage of the material in areas of deflection.

The ring may additionally be pre-flexed prior to deployment on a tubular member. For example, the plurality of projections may be at least partially deflected prior to deployment. Pre-flexing the ring may improve mechanical stability in areas of deflection of the plurality of projections. The projections may be at least partially deflected under pre-selected conditions to control mechanical stability and reduce the incidence of breakage during deployment on the tubular member. In some embodiments, the projections may be deflected to form a curve along the length of the projection, avoiding sharp angles at the base of the projections that tend to produce compromise stability.

In some embodiments, the contact angle may be selected based on yield strength and tensile strength of the semi-rigid material. In particular, the contact angle may be selected to provide a pre-determined resistance against the tubular member, for a given semi-rigid material having a known yield strength and tensile strength.

The ring and/or plurality of projections may each have a thickness of between about 0.1 mm and about 2.0 mm. For example, the ring and/or plurality of projections may have a thickness of between about 0.25 mm and about 1.75 mm, between about 0.5 mm and about 1.5 mm, between about 0.75 mm and about 1.5 mm, or between about 1.0 mm and about 1.5 mm.

The ring and/or plurality of projections may have a thickness of about 0.1 mm, about 0.25 mm, about 0.5 mm, about 0.75 mm, about 1.0 mm, about 1.25 mm, about 1.5 mm, about 1.75 mm, or about 2.0 mm. The thickness of the plurality of projections may be selected based on the yield strength and the tensile strength of the semi-rigid material. In particular, the thickness of the plurality of projections may be selected to provide a pre-determined resistance against the tubular member, for a given semi-rigid material having a known yield strength and tensile strength.

Thus, the scraper assembly may be engineered to provide a pre-determined resistance against the tubular member during use. The pre-determined resistance may be a resistance effective to remove foulant without damaging the tubular member. One or more properties of the scraper assembly may be selected to provide the pre-determined resistance. For instance, properties of the semi-rigid material, thickness of the ring and/or plurality of projections, and length of the plurality of projections may be selected during design of the scraper assembly. In general, longer projections (for example, having a length of 6 mm to 10 mm) provide lower resistance against the tubular member. The lower resistance and shallower contact angle produced by such projections may be effective to remove foulant while reducing the potential damaging effect on the tubular member.

Additionally, in some embodiments, the semi-rigid material may be selected to be substantially inert to the material of the tubular member and/or components of the fluid being treated. For example, the semi-rigid material may be chemically inert to components of the fluid being treated. The semi-rigid material may be chemically inert to other components of the water treatment system, such as quartz. In particular, the semi-rigid material may be selected to be substantially non-leaching in the fluid to be treated.

The ring may have a pre-determined number of projections. The number of projections may be defined by the number of radial cuts made on the interior surface of the ring. For a given inner diameter of the ring, the number of radial cuts may also define the thickness of each projection. In general, a greater amount of narrower projections produces a ring capable of conforming better to the surface of the tubular member. However, a greater amount of narrower projections also leaves a greater surface area of the tubular member without direct contact by a projection.

In some embodiments, each of the plurality of projections may make up an arc length of the primary ring of between about 4° and about 30°. For example, each of the plurality of projections may make up an arc length of between about 4° and about 20°, between about 4° and about 15°, between about 4° and about 10°, or between about 4° and about 8°. The ring may have between about 12 and about 45 projections. For example, the ring may have between about 20 and about 45, projections, between about 25 and about 45 projections, or between about 30 and about 45 projections. The arc length and number of projections may be selected to contact a pre-determined surface area of the tubular member. In some embodiments, the projections may contact more than 50% of the surface area, more than 60% of the surface area, more than 70% of the surface area, more than 80% of the surface area, or more than 90% of the surface area of the tubular member.

The scraper assembly may additionally comprise a casing. The casing may be employed as a housing or shell for other assembly components. The casing may be formed of one or more parts, at least partially surrounding other assembly components. When formed of more than one part, the parts of the casing may be fastened together by screws, bolts, fasteners, e.g., snap fastener elements, or any other fastening methods.

The casing may be constructed and arranged to drive the scraper assembly, including the ring, to traverse the exterior surface of the tubular member. Thus, the casing may provide mechanical support for assembly components, such as the ring. The casing, or casing parts, may individually be formed of any mechanically stable material, such as, stainless steel, spring steel, a natural polymer, a synthetic polymer, or combinations thereof. Exemplary steel materials include those mentioned above with respect to the ring, and other steel materials. The casing may have a greater yield strength and tensile strength than the ring. Exemplary polymer materials include acrylate polymers such as poly(methyl methacrylate), fluoropolymers such as polytetrafluoroethylene (PTFE), polysiloxane, and other materials with high mechanical stability. In some embodiments, the casing may be formed of a substantially transparent material, to allow visual inspection of the ring and other assembly components. In certain embodiments, the casing or casing parts may be formed of a chemically stable material in the fluid to be treated. For example, the material of the casing or casing parts may be substantially non-leaching in the fluid to be treated.

The ring may be fixed to the casing. For example, the ring may be fixed by screws, bolts, or other fasteners through the one or more fastener holes (e.g., holes 122 shown in FIG. 1). The ring may be fixed to the casing by any other fixing methods, such as, glue or adhesive, welding, or molding with the casing. In some embodiments, the screws, bolts, or fasteners employed to fasten the parts of the casing may be employed to fix the ring to the casing. When fixed, the casing may at least partially surround the ring. For example, the casing may at least partially surround an exterior surface of the ring. In general, the outer diameter of the ring 126 (shown in FIG. 2) may be equal to or smaller than the outer diameter of the casing. The projection length diameter 128 (shown in FIG. 2) may be equal to or smaller than the inner diameter of an interior opening of the casing. In embodiments in which the ring is designed to be retrofit to an existing casing, projection length may be varied by reducing inner diameter of the ring, since the outer diameter and projection diameter are determined by design of the casing.

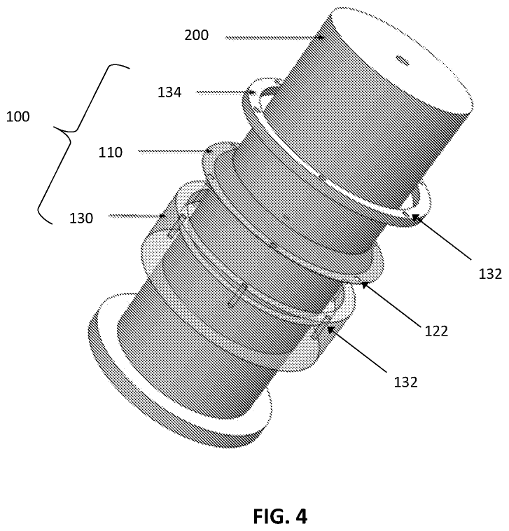

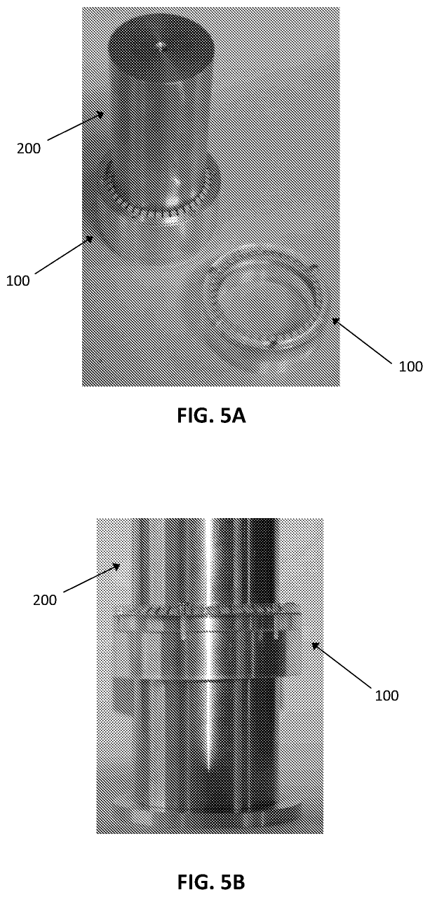

FIG. 4 is an expanded view of an exemplary scraper assembly 100 on a portion of a tubular member 200. The exemplary scraper assembly 100 comprises a ring 110 and a casing formed of parts 130, 134. Casing parts 130, 134 have fastener holes 132 which substantially correspond to fastener holes 122 on the ring 110. Common screws or bolts may be used through fastener holes 122 and 132 to construct the scraper assembly 100. When fixed, casing parts 130, 134 partially surround the ring 110 and provide mechanical stability to the ring 110. Exemplary casing part 134 is made of stainless steel and exemplary casing part 130 is made of acrylic. FIGS. 5A-5B are photographs of an exemplary scraper assembly 100 as shown in the drawing of FIG. 4.

In some embodiments, the scraper assembly may comprise a supplemental ring. The supplemental ring may be fixed to the casing, spaced apart from the primary ring. The supplemental ring and the primary ring may be substantially concentrically arranged within the casing. The supplemental ring may have a plurality of projections circumferentially offset from the primary ring. In particular, the secondary ring may be circumferentially arranged such that projections correspond to any gaps between projections on the primary ring.

In some embodiments, the primary ring and the supplemental ring may be similarly dimensioned. In other embodiments, the supplemental ring may have a larger or smaller inner diameter than the primary ring. The supplemental ring may have more or less projections than the primary ring. The plurality of projections on the supplemental ring may make up a larger or smaller arc length than the plurality of projections on the primary ring. The supplemental ring may have a larger or smaller thickness than the primary ring. The plurality of projections on the supplemental ring may have a greater or lesser length than the plurality or projections on the primary ring. Additionally, the supplemental ring may be formed of the same or different material than the primary ring. For example, the supplemental ring may have a greater or lesser yield strength and/or tensile strength than the primary ring.

In general, the properties of the more than one ring may be engineered to maximize removal of the target foulants from the tubular member. Each of the primary ring and the supplemental ring may be configured to contact at least 50% of the surface area of the tubular member. In some embodiments, an assembly comprising more than one ring may be configured to contact at least 80% of the surface area of the tubular member, for example, at least 82%, 85%, 87%, 90%, 92%, 95%, 97%, 98%, 99%, 99.9%, or 99.99% of the surface area of the tubular member.

The scraper assembly may comprise a spacer positioned between the primary ring and the supplemental ring. The spacer may provide mechanical stability for the primary ring and the supplemental ring. In some embodiments, the scraper assembly may comprise a spacer positioned on an outer surface of the primary and/or supplemental ring, for example, a surface facing an interior side of the casing. The spacer may have a thickness effective to separate points of contact of the primary ring and supplemental ring on the tubular member. Thus, the dimensions of the spacer may be selected based on the dimensions of the rings. The spacer may have a thickness of between about 2 mm to about 20 mm. The spacer may have a thickness of about 2 mm, about 4 mm, about 6 mm, about 8 mm, about 10 mm, about 12 mm, about 14 mm, about 16 mm, about 18 mm, or about 20 mm.

In some embodiments, the thickness of the scraper may be selected based on the length of the projections of the ring. The spacer may have a thickness of between about 0.5× and 2× the length of the projections of the ring. In embodiments where adjacent rings have projections of different lengths, the spacer may have a thickness of between about 0.5× and 2× the length of the longer projections. Thus, the spacer may have a thickness of about 0.5×, about 0.75×, about 1.0×, about 1.25×, about 1.5×, about 1.75×, or about 2× the length of the projections of the ring.

The spacer may be fixed to the casing. For example, the spacer may be fixed to the casing by the same method as either or both rings. In some embodiments, the spacer may have a circular opening and be arranged concentrically with the primary and supplemental rings. The spacer may have an inner diameter larger than the exterior diameter of the tubular member, such that the spacer does not contact the tubular member during use of the scraping assembly. In other embodiments, the spacer may be formed of one or more spacer elements positioned substantially equidistant from each other around a circumference of the rings' circular openings. For example, the spacer may comprise two, three, four, five, six, or more spacer elements positioned substantially equidistant from each other around the inner opening of the rings. The one or more spacers may be positioned to not contact the tubular member during use.

The spacer may be formed of a mechanically stable material. In some embodiments, the spacer may be formed of steel materials, such as those mentioned above with respect to the ring, and other steel materials, or polymer materials, such as acrylate polymers such as poly(methyl methacrylate), fluoropolymers such as polytetrafluoroethylene (PTFE), polysiloxane, and other materials.

In some embodiments, the scraper assembly may comprise a movement damping element. The movement damping element may comprise a material selected to absorb a degree of lateral motion by one or more assembly elements during use. The movement damping element may be formed of a polymeric material, for example, an acrylate polymer such as poly(methyl methacrylate), fluoropolymer such as polytetrafluoroethylene (PTFE), polysiloxane, or other material. In some embodiments, the movement damping element may be formed of a semi-flexible material. Exemplary semi-flexible materials include polyethylene, sorbothane, rubber, neoprene, silicone, or other materials.

The movement damping element may be positioned adjacent to the spacer. The movement damping element may be positioned adjacent to a ring. The movement damping element may be positioned adjacent to the casing. In some embodiments, the movement damping element may be integrated with the spacer, for example, as a coating or partial coating of the spacer. The movement damping element may be fixed to the casing. For example, the movement damping element may be fixed to the casing by the same method as a ring or the spacer.

In some embodiments, the movement damping element may have a circular opening and be arranged concentrically with the ring. The movement damping element may have an inner diameter larger than the exterior diameter of the tubular member, such that the movement damping element does not contact the tubular member during use of the scraping assembly. In other embodiments, the movement damping element may be formed of one or more elements positioned substantially equidistant from each other around a circumference of the rings' circular openings. For example, the movement damping element may comprise two, three, four, five, six, or more elements positioned substantially equidistant from each other around the inner opening of the rings. The one or more movement damping elements may be positioned to not contact the tubular member during use.

In general, the movement damping element may have any thickness effective to dampen movement of the scraper assembly components. In some embodiments, the movement damping element may have a thickness of 0.5× to 50× the thickness of the ring, for example, 2× to 10× the thickness of the ring. Exemplary movement damping elements may have a thickness between about 1 mm and about 5 mm.

In some embodiments, the scraper assembly may comprise more than two rings, each ring being circumferentially offset from at least one other ring. In some embodiments, each ring may be circumferentially offset from any adjacent rings. In some embodiments, each ring may be circumferentially offset from all rings in the assembly. The rings may be positioned substantially concentrically with each other. The scraper assembly may further comprise a spacer between each set of adjacent rings. In some embodiments, the scraper assembly may further comprise a spacer between an exterior ring and an interior side of the casing. In some embodiments, the scraper assembly may comprise a movement damping element between each set of adjacent rings. The scraper assembly may comprise a movement damping element between an exterior ring and an interior side of the casing.

The scraper assembly may further comprise a flexible ring. The flexible ring may be fixed to the casing. In some embodiments, the flexible ring may have an inner diameter less than the outer diameter of the tubular member. The flexible ring may be formed of rubber or a flexible polymeric material. One exemplary flexible polymeric material is a fluoropolymer such as polytetrafluoroethylene (PTFE). The flexible ring may be formed of a material having a greater flexibility than the movement damping element.

The flexible ring may be constructed and arranged to contact and traverse the exterior surface of the tubular member. In general, the flexible ring may be positioned in the assembly ahead of any ring in the forward direction. Thus, the flexible ring may be arranged to traverse the tubular member ahead of any ring comprising the plurality of projections. During use, the flexible ring may be employed to scrape easily removable contaminants, while the ring comprising the plurality of projections may be employed to remove hardened, greasy, or oily contaminants downstream from the flexible ring.

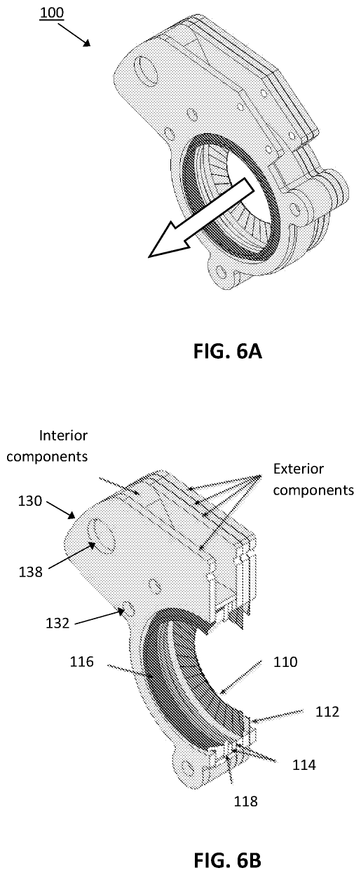

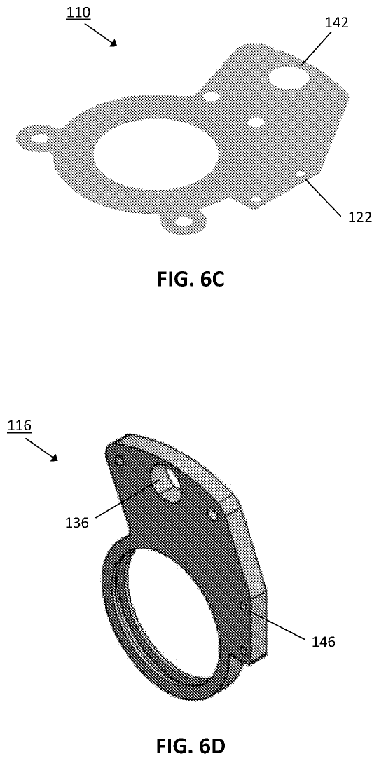

An exemplary scraper assembly is shown in FIGS. 6A-6B. FIG. 6A is a schematic drawing of an exemplary scraper assembly 100. FIG. 6B is a cutaway view of a portion of the scraper assembly 100 of FIG. 6A. The scraper assembly 100 comprises a casing 130, primary ring 110, supplemental ring 112, spacer 114, flexible ring 116, and movement damping element 118. The spacer 114 and movement damping element 118 are shown on an exterior side of primary ring 110. However, the spacer 114 and movement damping element 118 may be positioned between primary ring 110 and supplemental ring 112, or the scraper assembly 100 may comprise more than one spacer 114 and movement damping element 118. The exemplary primary ring 110 of scraper assembly 100 has 10 mm projections. The exemplary supplemental ring 112 of scraper assembly 100 has 6 mm projections. Any other combination of projection lengths may be employed. The exemplary scraper assembly 100 is configured to traverse the tubular member in the direction of the arrow shown in FIG. 6A, such that flexible ring 116 traverses the tubular member ahead of rings 110 and 112.

The casing 130 comprises through-hole 138, through which the scraper assembly 100 may be driven to traverse the exterior surface of a tubular member. The exemplary scraper assembly 100 of FIGS. 6A-6B is configured to traverse a track positioned in parallel to the tubular member. The casing 130 of exemplary scraper assembly 100 comprises additional fastener holes 132, which may be employed to fix the scraper assembly 100 to further driving or stabilizing elements within a treatment system.

An exemplary ring 110 configured to be fit on exemplary scraper assembly 100 is shown in FIG. 6C. An exemplary flexible ring 116 configured to be fit on exemplary scraper assembly 100 is shown in FIG. 6D. The exemplary ring 110 and exemplary flexible ring 116 comprise fastening holes 122 and 136, respectively, through which the ring 110 and flexible ring 116 may be fastened to the casing. The exemplary ring 110 and exemplary flexible ring 116 comprise through-holes 142 and 146, respectively, which correspond with the through-hole 138 on the casing 130 (shown in FIGS. 6A-6B).

Certain treatment systems comprise a plurality of optical devices. The scraper assembly may be configured to traverse the exterior surface of a plurality of tubular members arranged in parallel. A scraper assembly configured to scrape a plurality of tubular members may comprise an array of rings. The array of rings may be arranged in a planar configuration, with the interior opening of each of the plurality of rings positioned normal to the common plane. Each primary ring from the array of primary rings may be positioned to traverse the exterior surface of a corresponding tubular member.

The scraper assembly configured to traverse the exterior surface of a plurality of tubular members may comprise a casing configured to fit the plurality of rings in the planar configuration. For instance, the casing may comprise a plurality of openings, each opening position concentrically with a corresponding ring and tubular member. The casing for the plurality of tubular members may comprise a single through-hole through which the scraper assembly may be driven to traverse the exterior surface of the plurality of tubular members. In other embodiments, the casing for the plurality of tubular members may comprise more than one through-hole.

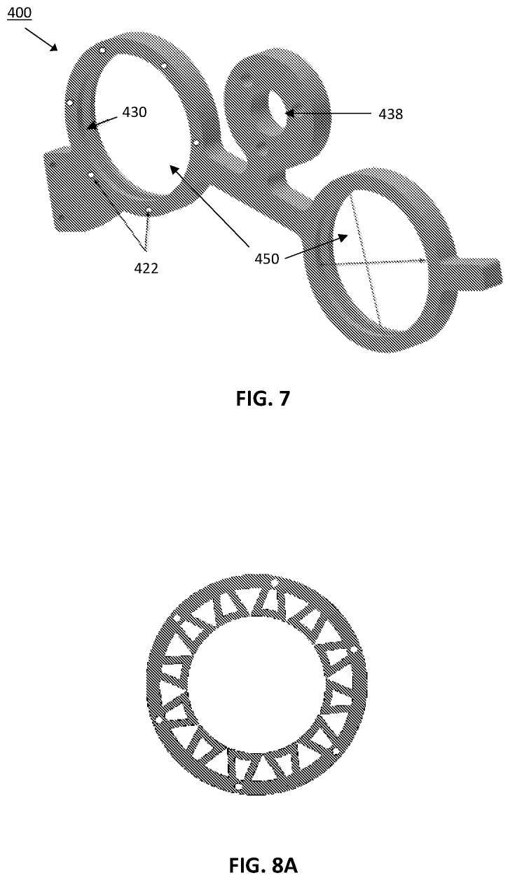

FIG. 7 is a schematic drawing of a scraper assembly 400 for cleaning a plurality of tubular members. The scraper assembly 400 comprises a casing 430 with a plurality of openings 450 configured to house the ring and other assembly components. The casing 430 of the scraper assembly 400 comprises through-hole 438 through which the scraper assembly 400 can be driven to traverse the exterior surface of a plurality of tubular members arranged in parallel. The casing 430 of the scraper assembly 400 comprises fastener holes 422.

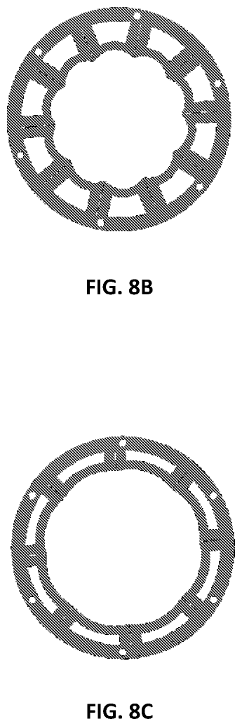

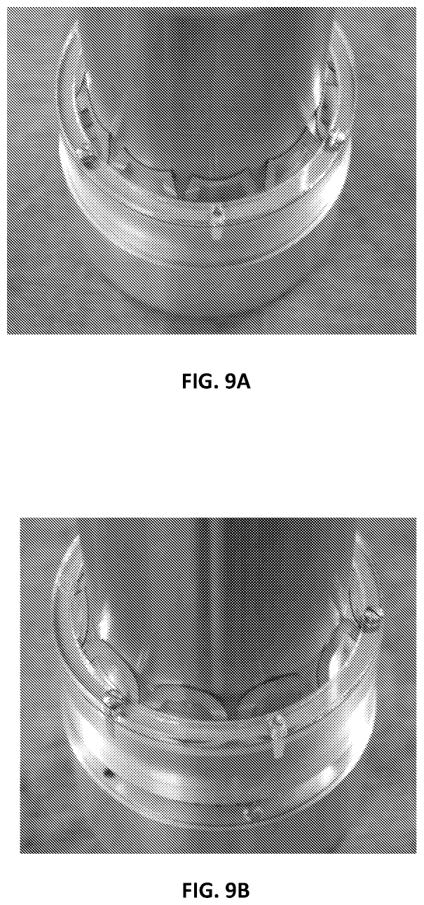

In some embodiments, the plurality of projections may be designed to increase contact area with the tubular member. For example, the radius of curvature of the interior surface of the projection may be varied to increase contact area. In certain embodiments, the interior surface of the projection may have a smaller radius of curvature than a corresponding outer diameter of the ring. In other embodiments, the interior surface of the projection may be convex. Exemplary designs are shown in FIGS. 8A-8C. Photographs of exemplary designs employed on tubular members are shown in FIGS. 9A-9B. Specifically, the designs of FIGS. 8B-8C and FIG. 9A show projections with a smaller radius of curvature. The design of FIG. 9B shows convex projections.

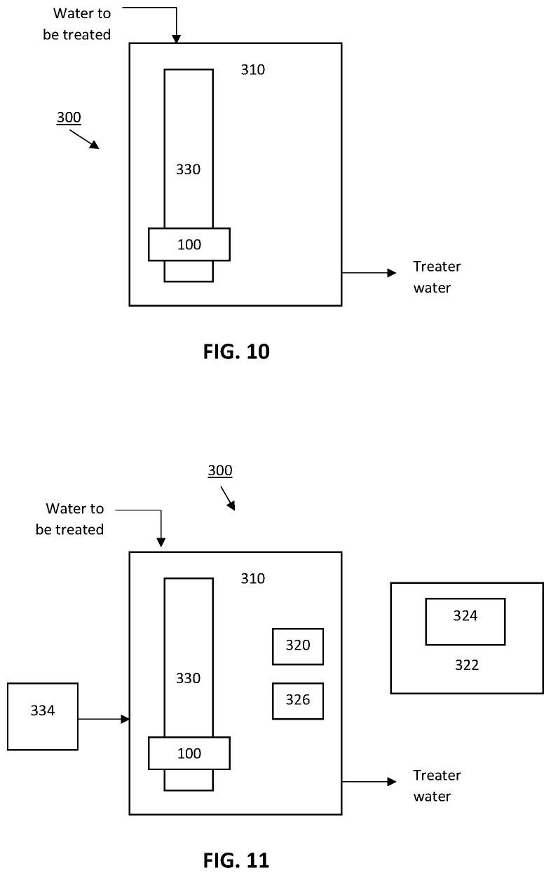

The projections may be designed to reduce unwanted accumulation of scraped contaminants in the casing or at one end of the tubular member. The exemplary designs of FIGS. 8A-8C and 9A-9B have projections with central openings. The central openings may allow contaminants to flow through the projections when scraped from the tubular member, avoiding problematic accumulation of these contaminants. Such rings may contain a lesser amount of larger projections, for example, six to twelve projections. For example, such rings may contain 6, 8, 10, or 12 projections comprising central openings. Additionally, the ring may be designed to have a smaller number of projections, for example, 20 projections or less, 12 projections or less, or 8 projections or less. In general, reducing a number of projections may increase contact area of the projections on the tubular member, by reducing total area of gaps between projections. In accordance with another aspect, there are provided systems and methods for water treatment system with ultraviolet irradiation. FIG. 10 is a box diagram of an exemplary water treatment system 300. The system 300 may comprise a vessel 310 having an inlet and an outlet, at least one light source assembly 330 positioned within the vessel 310, comprising an ultraviolet light housed in a quartz sleeve, and a scraper assembly 100 configured to traverse an exterior surface of the at least one light source assembly 330.

The system may further comprise a controller operatively connected to the scraper assembly. The controller may be configured to operate the scraper assembly to traverse the exterior surface of the at least one light source assembly. The controller may operate the scraper assembly responsive to manual actuation, periodically on a pre-determined schedule, or responsive to ultraviolet light intensity.

The controller may be a computer or mobile device. The controller may comprise a touch pad or other operating interface. For example, the controller may be operated through a keyboard, touch screen, track pad, and/or mouse. The controller may be configured to run software on an operating system known to one of ordinary skill in the art. The controller may be electrically connected to a power source. The controller may be digitally connected to the one or more components. The controller may be connected to the one or more components through a wireless connection. For example, the controller may be connected through wireless local area networking (WLAN) or short-wavelength ultra-high frequency (UHF) radio waves. The controller may further be operably connected to any pump or valve within the system, for example, to enable the controller to direct fluids or additives as needed. The controller may be coupled to a memory storing device or cloud-based memory storage.

Multiple controllers may be programmed to work together to operate the system. For example, a controller may be programmed to work with an external computing device. In some embodiments, the controller and computing device may be integrated. In other embodiments, one or more of the processes disclosed herein may be manually or semi-automatically executed. The pre-determined schedule to operate the scraper assembly to traverse the quartz sleeve may include operating the scraper assembly on periods of twelve hours or longer. For example, the controller may be configured to operate the scraper assembly once every twelve hours or longer. The controller may be configured to operate the scraper assembly every 12 hours, every 15 hours, every 18 hours, every 21 hours, or every 24 hours. The pre-determined schedule may correspond to periods of operation of the water treatment system. In particular, the controller may be configured to operate the scraper assembly once every twelve hours of substantially continuous operation of the system or longer.

In some embodiments, the system may comprise an ultraviolet light sensor. The ultraviolet light sensor may be positioned to monitor ultraviolet light intensity through the water treatment system, for example, to determine ultraviolet light intensity or dosage applied to the water being treated. The ultraviolet light sensor may be configured to display measured ultraviolet light intensity, for example, on a display unit operatively connected to the sensor, or notify a user of the measured ultraviolet light intensity, for example, by electronic notification to a computing or mobile device.

A user may actuate the scraper assembly responsive to the measured ultraviolet light intensity being below a pre-determined threshold. In general, the scraper assembly may be actuated to traverse the quartz sleeve responsive to a measured ultraviolet light intensity indicating an applied ultraviolet light dosage is below an effective level to treat the water. Thus, in some embodiments, the methods may comprise measuring flowrate and calculating ultraviolet light dosage. The systems may comprise a flowmeter operatively connected to the display unit and/or controller.

The effective amount of ultraviolet irradiation may be associated with an effective dosage (minimum intensity and exposure time) of ultraviolet irradiation for the target treatment process. For example, the effective amount of ultraviolet irradiation may be selected based on treatment of a target contaminant, for example, sterilization of a target percentage (e.g., more than 90%, more than 95%, more than 99%, or more than 99.99%) of a target microorganism in the fluid, traveling through the system at a known given rate. In some embodiments, the threshold ultraviolet light intensity may be an intensity associated with a dosage effective to sterilize a target percentage of one or more bacteria selected from Escherichia coli, a species of Leptospira, a species of Salmonella (e.g., Salmonella typhi), a species of Shigella, or Vibrio cholerae; a protozoa selected from Balantidium coli, Cryptosporidium parvum, Entamoeba histolytica, or Giardia lamblia; a helminths selected from Ascaris lumbricoides, Taenia solium, or Trichuris trichiura; or a virus selected from a species of Enterovirus, Hepatitis A virus, Norwalk agent, a species of Rotavirus, a species of Coronavirus, or a species of Influenza virus. The threshold ultraviolet light intensity may be an intensity associated with an ultraviolet light dosage of less than 25 mJ/cm², less than 20 mJ/cm², less than 15 mJ/cm², less than 10 mJ/cm², or less than 5 mJ/cm².

In some embodiments, the controller may be operatively connected to the ultraviolet light sensor. The controller may be configured to operate the scraper assembly to traverse the exterior surface of the light source assembly responsive to the monitored ultraviolet light intensity being below the threshold value. In certain embodiments, the controller may be operatively connected to the flowmeter. The controller may be configured to calculate ultraviolet light dosage from the measured ultraviolet light intensity and the measured flowrate. The controller may further be configured to operate the scraper assembly to traverse the exterior surface of the light source assembly responsive to a measured ultraviolet light dosage applied to the water being treated.

In some embodiments, the system may further comprise a source of a chemical cleaner fluidly connected to the vessel. The source of the chemical cleaner may be operatively connected to the controller. In some embodiments, the systems and methods described herein may comprise dosing the water treatment system with a chemical cleaner before, during, or after traversing the quartz sleeve with the scraper assembly. The chemical cleaner may be selected based on the target application of the disinfected solution. In some embodiments, the chemical cleaner may be substantially free of harmful or toxic byproducts. Exemplary chemical cleaners include sodium hydrosulfite, citric acid, and vinegar solutions. The method may comprise manually discharging the chemical cleaner into the system. In other embodiments, the controller may be configured to discharge the chemical cleaner into the system.

FIG. 11 is a box diagram of an exemplary water treatment system 300. The water treatment system 300 is similar to the water treatment system 300 shown in FIG. 10, but further including an ultraviolet light sensor 320 operatively connected to controller 322 and display unit 324. The exemplary water treatment system 300 of FIG. 11 further includes flowmeter 326 operatively connected to controller 322. The exemplary water treatment system 300 of FIG. 11 further includes source of chemical cleaner 334 fluidly connected to vessel 310.

In certain embodiments, the water treatment system may comprise more than one ultraviolet light assembly arranged in parallel. Such a system may comprise a scraper assembly configured to traverse the exterior surface of the plurality of ultraviolet light assemblies. Other systems may comprise a plurality of scraper assemblies. The system may be configured to operate scraper assemblies independently. For instance, the system may be capable of isolating one or more scraper assemblies for replacement or maintenance, while the remaining scraper assemblies continue to operate normally.

The method of water treatment may comprise introducing a source of water to be treated into the vessel and irradiating the water to be treated with an effective amount of ultraviolet irradiation to treat the water. Thus, the method may comprise measuring ultraviolet light irradiation and measuring or controlling flow rate of the water through the vessel to determine an applied ultraviolet light dosage. The method may further comprise discharging treated water from the vessel.

The methods disclosed herein may include removing organic material fouling from an exterior surface of the quartz sleeve. The method may comprise directing the scraper assembly to traverse the exterior surface of the quartz sleeve in a first direction to scrape at least 50% of the organic material fouling from the exterior surface of the quartz sleeve. In some embodiments, the method may comprise directing the scraper assembly to traverse the exterior surface of the quartz sleeve to scrape at least 60% of the organic material fouling, for example, at least 70%, at least 80%, or at least 90% of the organic material fouling. The amount of fouling scraped from the quartz sleeve may be increased by scraper assembly design, as previously described. Thus, in certain embodiments, the methods may comprise designing a scraper assembly to scrape at least 50%, 60%, 70%, 80%, or 90% of the organic material fouling from the quartz sleeve. The method may further comprise resetting the scraper assembly by directing the scraper assembly to traverse the exterior surface of the quartz sleeve in a second direction, opposite the first direction.

In some embodiments, the method may comprise periodically directing the scraper assembly to traverse the exterior surface of the quartz sleeve on a pre-determined schedule. The pre-determined schedule may be every twelve hours or longer, as previously described.

In some embodiments, the method may comprise monitoring ultraviolet light intensity through the water treatment system, as previously described. For example, ultraviolet light intensity may be measured with an ultraviolet light intensity sensor. The ultraviolet light intensity may be monitored by periodic notifications of the measured ultraviolet light intensity. In certain embodiments, the methods may comprise directing the scraper assembly to traverse the exterior surface of the quartz sleeve responsive to the measured ultraviolet light intensity being below a threshold value, as previously described. The scraper assembly may be directed upon manual actuation or automatically by a controller operatively connected to the ultraviolet light sensor.

In some embodiments, the method may comprise monitoring flow rate of the water through the water treatment system, as previously described. For example, flow rate may be measured with a flowmeter. Flow rate may be monitored by periodic notifications of the measured flow rate. The method may comprise calculating ultraviolet light dosage based on measured ultraviolet light intensity and flow rate. Ultraviolet light dosage may be manually calculated, or automatically calculated by a controller operatively connected to the ultraviolet light sensor and the flowmeter. In certain embodiments, the methods may comprise directing the scraper assembly to traverse the exterior surface of the quartz sleeve responsive to the measured ultraviolet light dosage being below a threshold value, as previously described. The scraper assembly may be directed upon manual actuation or automatically by the controller.

In some embodiments, the method may further comprise applying a chemical cleaning process before or concurrently while directing the scraper assembly to traverse the exterior surface of the quartz sleeve. The chemical cleaning process may comprise dosing the water to be treated with a chemical cleaner, for example, within a vessel comprising the ultraviolet light source as previously described. The method may comprise applying the chemical cleaning process every instance that the scraper assembly is directed to traverse the exterior surface of the quartz sleeve, or less than every instance that the scraper assembly is directed to traverse the exterior surface of the quartz sleeve. In some embodiments, the method may comprise applying the chemical cleaning process once every 12 hours, every 15 hours, every 18 hours, every 21 hours, every 24 hours, every 36 hours, every 48 hours, every 72 hours, or weekly.

The systems and assemblies disclosed herein may have a greater lifespan then conventional quartz sleeve cleaning devices. In some embodiments, the methods disclosed herein may comprise operating the water treatment system substantially continuously for at least about six months before replacing the scraper assembly or the ring. For example, the methods disclosed herein may comprise operating the water treatment system substantially continuously for at least about 6 months, about 8 months, about 10 months, or about 12 months before replacing the scraper assembly or the ring.

Additionally, the systems and assemblies disclosed herein may provide a greater lifespan to the quartz sleeve then conventional quartz sleeve cleaning devices. In some embodiments, the methods disclosed herein may comprise operating the water treatment system substantially continuously for at least about five years before replacing the quartz sleeve. For example, the methods disclosed herein may comprise operating the water treatment system substantially continuously for at least about 5 years, about 6 years, about 7 years, about 8 years, about 9 years, about 10 years, about 11 years, or about 12 years before replacing the quartz sleeve.

In accordance with another aspect, there is provided a method of retrofitting an existing water treatment system having at least one ultraviolet light source. The method may generally comprise providing a scraper assembly configured to traverse an exterior surface of the at least one light source assembly, as previously described. The method may further comprise providing instructions to install the scraper assembly by the casing to drive the scraper assembly to traverse the exterior surface of the at least one light source assembly, as previously described.

In some embodiments, the method may comprise providing a ring comprising a plurality of projections, as previously described. The ring may be dimensioned to correspond with an existing casing. For example, the outer diameter of the ring 126 (shown in FIG. 2) and the projection diameter 128 (shown in FIG. 2) may be dimensioned to correspond to the outer diameter and inner diameter of the target casing. The method may comprise providing instructions to install the ring onto a casing of a scraper assembly, as previously described.

Certain water treatment systems include a track constructed and arranged to guide the scraper assembly by the casing to traverse the exterior surface of the at least one light source assembly. The method may comprise providing the scraper assembly compatible with the existing track. In other embodiments, the method may comprise providing instructions to install a track to guide the scraper assembly by the casing to traverse the exterior surface of the at least one light source assembly.

Assemblies or components disclosed herein may be designed to be compatible with existing water treatment or quartz sleeve cleaning devices. For example, the ring may be dimensioned to correspond with conventional rubber cleaning devices. In particular, the ring may be dimensioned to fit a casing designed for a rubber cleaning device. The method may comprise replacing a rubber cleaning device with a ring, as disclosed herein. The method may further comprise supplementing a rubber cleaning device with a ring, as disclosed herein. In some embodiments, the method may comprise providing one or more of a supplemental ring, a spacer, and a movement damping element, and installing one or more of the supplemental ring, the spacer, and the movement damping element on a casing including a rubber cleaning device or primary ring.

In accordance with yet another aspect, there is provided a method of manufacturing a scraper assembly, as previously described. The method may comprise selecting one or more dimension of the ring, such as inner diameter or thickness. The method may comprise selecting a material for the ring, e.g., a semi-rigid material to form the ring and/or the plurality of projections.

The method may comprise selecting one or more dimension of the ring. For example, the method may comprise selecting inner diameter of the ring. Inner diameter of the ring may be selected based on the material of the ring, size of a target tubular member, and/or target contact angle. Thus, the method may comprise selecting a length of the plurality of projections, which corresponds with inner diameter of the ring, as previously described. The length of the plurality of projections may be selected based on the material of the ring, size of the target tubular member, and/or target contact angle.

The method may comprise selecting a dimension of the plurality of projections. For example, the method may comprise selecting arc length of each projection. The selected arc length of each projection may be selected based on a target size and/or number of projections. The selected arc length of each projection may be selected based on a target contact area of the plurality of projections on the tubular member. Additionally, the method may comprise selecting a design for the interior surface of the projections and/or selecting a dimension for an inner opening of the projections, as shown in FIGS. 8A-8C and 9A-9B.

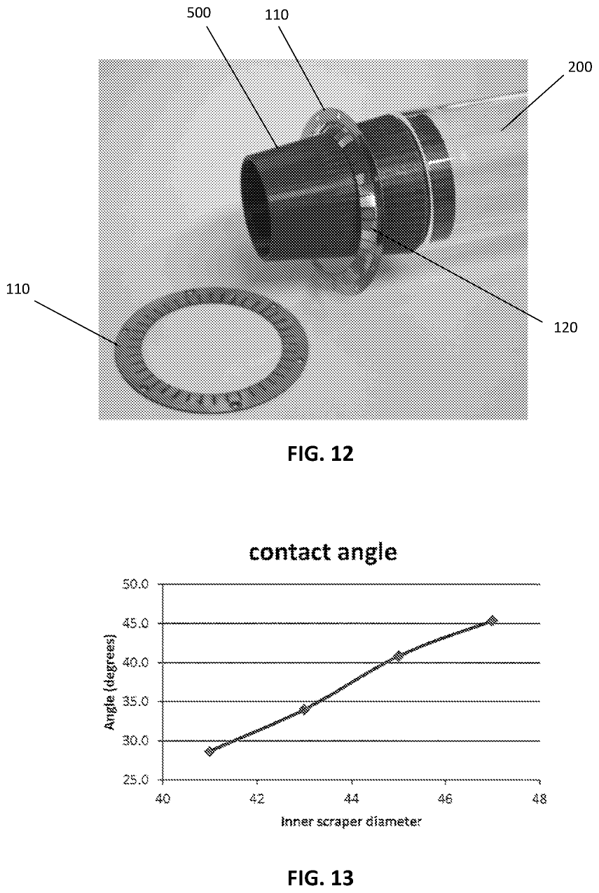

The method may comprise forming the ring by laser cutting a design of the selected dimensions from a sheet of the selected semi-rigid material having the desired thickness. The method may comprise heat treating or annealing the ring to a degree effective to reduce the incidence of breakage of the selected material in areas of deflection of the projections. The method may comprise pre-flexing the projections prior to deployment on a tubular member to improve mechanical stability in areas of deflection of the projections. The method may comprise pre-flexing the projections with a tapering device 500 as shown in FIG. 12. The tapering device 500 may be used to pre-flex the projections 120 prior to deployment on a tubular member. In other embodiments, the tapering device 500 may be used to flex the projections 120 in situ upon deploying the ring 110 on the tubular member 200 (as shown in the photograph of FIG. 12). The photograph of FIG. 12 shows a ring 110 prior to pre-flexing (left) and a ring 110 during pre-flexing (loaded on tapering device 500). The tapering device 500 may be a cone-shaped device formed of steel or a polymeric material. In some embodiments, the tapering device 500 may be 3D printed.

The method may comprise assembling the scraper assembly by fastening the ring and the casing. The method may comprise fastening one or more of a supplemental ring, a spacer, and a movement damping element to the ring and the casing to form the scraper assembly.

### EXAMPLES

The function and advantages of these and other embodiments can be better understood from the following examples. These examples are intended to be illustrative in nature and are not considered to be limiting the scope of the invention.

### Example 1: Deflection Angle of the Projections

It is expected that longer projection length produces a greater deflection of the projections against the surface of the quartz sleeve, and a shallower contact angle with the quartz sleeve.

To measure deflection angles, a small test rig was built. The test rig is shown in FIGS. 5A-5B. A steel tube was used to simulate a quartz tube. A casing was fit over the test ring in clear acrylic and steel parts. The test rings were bolted to the casing, sandwiched between a collar and a small retaining ring to provide stability and rigidity.

The test rings were laser cut from cardboard. The deflection of the projections against the test rig were measured. From these measurements, the contact angle made by the projections against the quartz tube were calculated. The results are shown in Table 2 below and the graph of FIG. 13. Contact angle was measured using the geometric values from the diagram of FIG. 3B and the formula above.

TABLE 2
Contact Angle as a Function of Projection Length
Outer diameter = 64 mm
Slot diameter = 56 mm
Casing depth = 2 mm

| | Inner | Opposite | | Actual | |
|---|---|---|---|---|---|
| Projection | diameter | diameter | Measured | deflection | Contact |
| length (mm) | (mm) | (mm) | gap (mm) | (mm) | angle (°) |
| 7.5 | 41 | 3.5 | 4.4 | 6.4 | 28.7 |
| 6.5 | 43 | 3.5 | 3.2 | 5.2 | 33.9 |
| 5.5 | 45 | 3.5 | 2.05 | 4.05 | 40.8 |
| 4.5 | 47 | 3.5 | 1.46 | 3.46 | 45.3 |

The results provide a rough scale of contact angle as a function of projection length. As shown in Table 2 and the graph of FIG. 13, increasing projection length tends to decrease contact angle.

### Example 2: Ring Materials

For preliminary testing, rings were formed of 316 stainless steel and polytetrafluoroethylene (PTFE) of varying thicknesses as shown in Table 3 below.

TABLE 3
Ring Dimensions

| Projection | PTFE | | | 316 stainless steel |
|---|---|---|---|---|
| length (mm) | thickness (mm) | | | thickness (mm) |
| 7.5 | 0.2 | 0.5 | 1.5 | 0.2 |
| 6.5 | 0.2 | 0.5 | 1.5 | 0.2 |
| 5.5 | 0.2 | 0.5 | 1.5 | 0.2 |
| 4.5 | 0.2 | 0.5 | 1.5 | 0.2 |

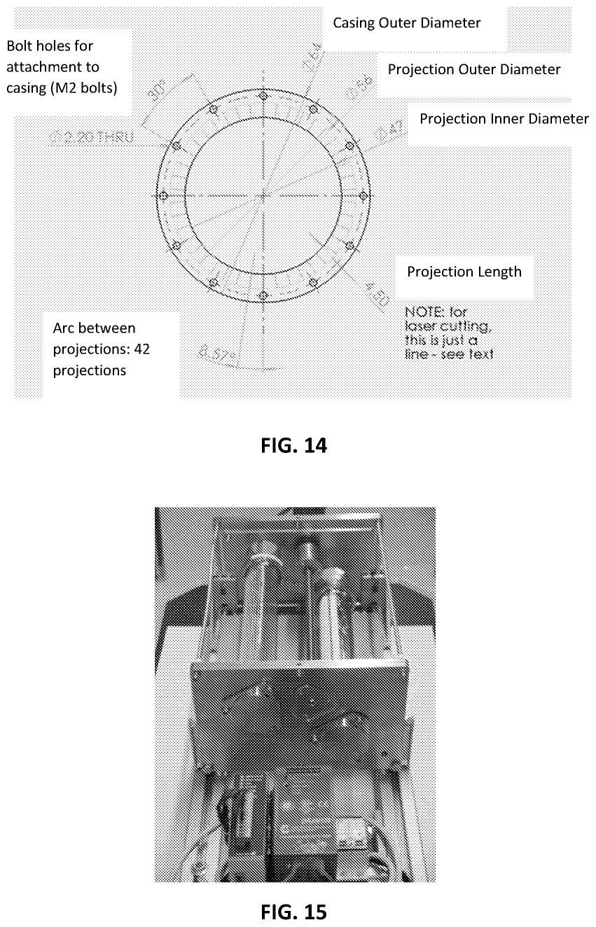

The rings were laser cut according to the design shown in FIG. 14 with a kerf of 0.1 mm. The outer diameter of the ring was selected to match the outer diameter of an existing carrier. The projection diameter was selected to match the inner diameter of the existing carrier. The design of FIG. 14 has a projection length of 4.5 mm.

The rings were tested in a test rig shown in the photograph of FIG. 15. A number of coatings were applied to the quartz sleeve to simulate problematic fouling:

1. Correction fluid (hexane solvent): simulates precipitation sedimentation fouling

2. Emulsion paint (water solvent): simulates precipitation sedimentation fouling

3. Lipstick: simulates oil, grease, and microbiological fouling

The emulsion paint and correction fluid were applied with a brush to sections of the quartz sleeve. The lipstick was smeared on to sections of the quartz sleeve.

The test rig had two short quartz tubes (outer diameter of 49 mm) and a casing (ATG-UV W5449999 distributed by Evoqua Water Technologies LLC, Pittsburgh, Pa.) attached to a worm drive mechanism which, when powered by a small electric motor, causes the casing to traverse the length of the quartz tubes then return to its starting position. The ATG-UV casing is designed to hold to rubber scrapers in internal grooves. The test device was modified by drilling holes through both sides to accommodate rings.

Two test assemblies were created: (a) two rings and (b) one ring and one flexible ring (rubber). For both assemblies, a spacer (steel retaining ring) was placed ahead of the ring in the forward direction to minimize distortion of the ring under load.

The test assemblies were loaded onto the rig. The quartz tubes were eased into the rig and through the test assemblies from the back face of the casing, in order to flex the projections in the forward direction. The quartz tubes were locked in position using standard threaded end caps.

Thicker rings and/or rings with shorter projections were more difficult to fit onto the quartz tube. To alleviate the difficulty, a tapering device was designed (shown in FIG. 12). The tapering device could be used to pre-flex the projections by manually pushing the ring onto the device or flexing the projections in situ by placing the tapering device on one end of the quartz tube before inserting it into the ring. The tapering device was initially produced by 3D printing. The 3D printed devices were problematic because ridges inherent to FDM 3D printing were formed, which made it difficult to ease the ring off the tapering device. Subsequently, a steel version was produced. Thus, the tapering device may have a smooth exterior surface.

Test runs were performing by the following steps: the projections were pre-flexed manually on the tapering device; the rings were attached to the casing in situ on the rig to form the scraper assembly; the quartz tubes were eased into the rig and through the scraper assembly and locked in position using end caps; the motor was engaged and the scraper assembly was moved to a start position at one end of the quartz tube; sample foulants were applied onto the quartz tube and allowed to dry for at least one hour; before photographs were taken, the motor was engaged to move the scraper assembly one complete traverse of the quartz tube (i.e., moved to the far end of the tube and returned to the starting position; during movement, still photographs or video were taken; after photographs were taken once the scraper assembly was returned to the start position at the first end of the quartz tube; in certain tests, a second traverse of the scraper assembly was performed; efficiency of removal was analyzed by comparing before and after photographs, and/or examining video recordings.

The results are presented in Table 4 below. In Table 4, “C” refers to correction fluid, “E” refers to emulsion paint, “L” refers to lipstick, “nd” indicates the test was not done, “x” indicates failure, and “v” indicates successful removal.

TABLE 4
Rig Test Outcomes

| Projection | 316 Stainless Steel | | | PTFE 0.2 mm & | | | PTFE 1.5 mm | | |
|---|---|---|---|---|---|---|---|---|---|
| length | 0.2 mm thickness | | | 0.5 mm thickness | | | thickness | | |
| (mm) | C | E | L | C | E | L | C | E | L |

| | | | | | | | |
|---|---|---|---|---|---|---|---|
| 7.5 | v | v | v | No experiments | x | x | nd |
| 6.5 | nd | nd | nd | performed, not | x | x | v |
| 5.5 | v | v | v | mechanically stable | x | x | v |

| | | | | |
|---|---|---|---|---|
| 4.5 | Unable to mount ring | x | x | nd |

As shown in Table 4, PTFE rings having a thickness of 0.2 mm or 0.5 mm and 316 stainless steel rings having a projection length of 4.5 mm were unable to be mounted on the quartz tube. The PTFE rings having a thickness of 1.5 mm did not remove correction fluid or emulsion paint, but successfully removed lipstick. The 316 stainless steel rings successfully removed correction fluid, emulsion paint, and lipstick.

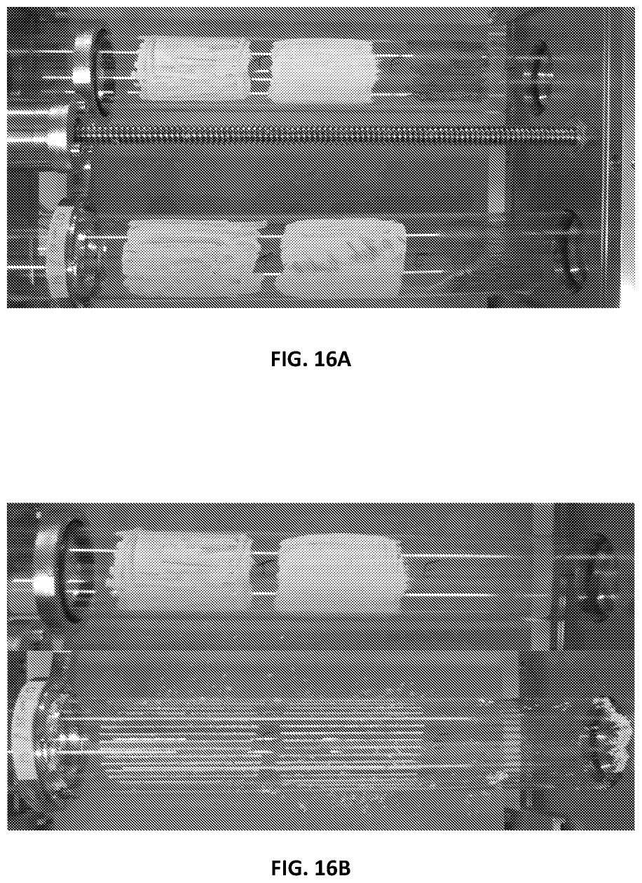

FIGS. 16A-16B are photographs of the quartz tubes before and after sample test runs. Specifically, FIG. 16A is a photograph of the quartz tubes with sample foulants before test runs. FIG. 16B is a photograph of the quartz tubes with sample foulants after test runs. The top image was scraped with a PTFE 1.5 mm ring. The bottom image was scraped with a 316 stainless steel 0.2 mm ring having projections of 7.5 mm.

### Example 5: Projections Having a Secondary Radius of Curvature

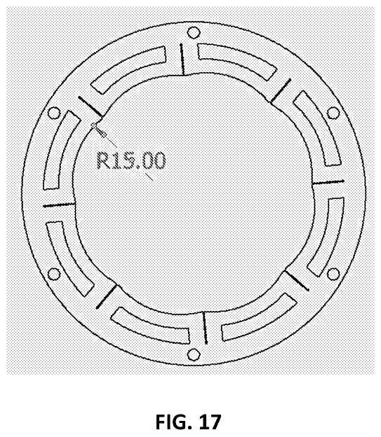

A ring design having larger projections with interior openings for clearance of scraped foulants was produced and tested. The projections were given a secondary radius of curvature on the interior end. The aim of the design was to retain clearance of scraped foulants through the interior opening and focus pressure across the width of the projection surface. The tested design is shown in the drawing of FIG. 17.

The ring design was tested against the sample foulants described in Example 2. After traversing the surface, the ring design retained clearance of scraped sample foulants. Unfortunately, the ring design did not apply enough pressure at the center of the projections and only scraped sample foulants by the ends of the projections. While the ring design did not remove sufficient sample foulant, it is believed the secondary radius of curvature may be optimized to remove a greater amount of foulant by varying (reducing) the secondary radius of curvature.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A scraper assembly configured to traverse an exterior surface of a tubular member, the scraper assembly comprising:
a casing constructed and arranged to drive the scraper assembly to traverse the exterior surface of the tubular member; and
a primary ring fixed to the casing, having a plurality of projections formed of a semi-rigid material extending inward toward the exterior surface of the tubular member, the plurality of projections having a length selected to define:
an inner diameter of the primary ring less than an outer diameter of the tubular member when the plurality of projections are in an extended configuration, and
a contact angle formed between the plurality of projections and the exterior surface of the tubular member of between about 15° and about 75° when the plurality of projections are in an inclined configuration.

2. The scraper assembly of claim 1, further comprising a supplemental ring fixed to the casing having a plurality of projections circumferentially offset from the primary ring.

3. The scraper assembly of claim 2, further comprising a spacer fixed to the casing positioned between the primary ring and the supplemental ring.

4. The scraper assembly of claim 1, further comprising a flexible ring fixed to the casing having an inner diameter less than the outer diameter of the tubular member.

5. The scraper assembly of claim 1, configured to traverse the exterior surface of a plurality of tubular members arranged in parallel, the scraper assembly comprising an array of primary rings, each primary ring from the array of primary rings positioned to traverse the exterior surface of a corresponding tubular member.

6. The scraper assembly of claim 1, wherein the semi-rigid material has a yield strength of between about 215 MPa and 290 MPa and a tensile strength of between about 505 MPa and 620 MPa.

7. The scraper assembly of claim 6, wherein the length of the plurality of projections are selected to define the contact angle based on the yield strength and the tensile strength of the semi-rigid material.

8. The scraper assembly of claim 6, wherein the plurality of projections each have a thickness of between about 0.1 mm and about 2.0 mm, selected based on the yield strength and the tensile strength of the semi-rigid material.

9. The scraper assembly of claim 1, wherein each of the plurality of projections makes up an arc length of the primary ring of between about 4° and about 30°.

10. The scraper assembly of claim 1, wherein an interior surface of the plurality of projections has a smaller radius of curvature than a corresponding outer diameter of the primary ring.

11. A water treatment system comprising:
a vessel having an inlet and an outlet;
at least one light source assembly positioned within the vessel, comprising an ultraviolet light housed in a quartz sleeve;
a scraper assembly configured to traverse an exterior surface of the at least one light source assembly, the scraper assembly comprising:
a casing constructed and arranged to drive the scraper assembly to traverse the exterior surface of the at least one light source assembly; and
at least one ring fixed to the casing, each ring positioned to traverse the exterior surface of a corresponding light source assembly, each ring having a plurality of projections formed of a semi-rigid material extending inward toward the exterior surface of the corresponding light source assembly, the plurality of projections having a length selected to define:
an inner diameter of the ring less than an outer diameter of the tubular member when the plurality of projections are in an extended configuration, and
a contact angle formed between the plurality of projections and the exterior surface of the corresponding light source assembly of between about 15° and about 75° when the plurality of projections are in an inclined configuration.

12. The system of claim 11, further comprising an ultraviolet light sensor positioned to monitor ultraviolet light intensity through the water treatment system.

13. The system of claim 12, further comprising a controller operatively connected to the ultraviolet light sensor and the scraper assembly, configured to operate the scraper assembly to traverse the exterior surface of the at least one light source assembly responsive to the monitored ultraviolet light intensity being below a threshold value.

14. The system of claim 11, further comprising a controller operatively connected to the scraper assembly, configured to operate the scraper assembly to traverse the exterior surface of the at least one light source assembly responsive to manual actuation or periodically on a pre-determined schedule.

16. The system of claim 11, wherein the semi-rigid material is selected to be substantially inert to the quartz sleeve and components of the water to be treated.

17. The system of claim 11, further comprising a source of a chemical cleaner fluidly connected to the vessel.

18. A method of retrofitting a water treatment system including at least one light source assembly including an ultraviolet light housed in a quartz sleeve, the method comprising:
providing a scraper assembly configured to traverse an exterior surface of the at least one light source assembly, the scraper assembly comprising:
a casing constructed and arranged to drive the scraper assembly to traverse the exterior surface of the at least one light source assembly; and
at least one ring fixed to the casing, each ring positioned to traverse the exterior surface of a corresponding light source assembly, each ring having a plurality of projections formed of a semi-rigid material extending inward toward the exterior surface of the corresponding light source assembly, the plurality of projections having a length selected to define:
an inner diameter of the ring less than an outer diameter of the tubular member when the plurality of projections are in an extended configuration, and
a contact angle formed between the plurality of projections and the exterior surface of the corresponding light source assembly of between about 15° and about 75° when the plurality of projections are in an inclined configuration; and
providing instructions to install the scraper assembly by the casing to drive the scraper assembly to traverse the exterior surface of the at least one light source assembly.

19. The method of claim 18, wherein the water treatment system includes a track constructed and arranged to guide the scraper assembly by the casing to traverse the exterior surface of the at least one light source assembly, the method further comprising providing the scraper assembly compatible with the track.

20. The method of claim 18, further comprising providing instructions to install a track to guide the scraper assembly by the casing to traverse the exterior surface of the at least one light source assembly.

21. A method of removing organic material fouling from an exterior surface of a quartz sleeve positioned within a water treatment system comprising an ultraviolet light housed in the quartz sleeve and a scraper assembly configured to traverse the exterior surface the quartz sleeve, the scraper assembly comprising a casing constructed and arranged to drive the scraper assembly to traverse the exterior surface of the quartz sleeve and a ring fixed to the casing having a plurality of projections formed of a semi-rigid material extending inward toward the exterior surface of the quartz sleeve, the method comprising:
directing the scraper assembly to traverse the exterior surface of the quartz sleeve in a first direction to scrape at least 80% of the organic material fouling from the exterior surface of the quartz sleeve.

22. The method of claim 21, comprising periodically directing the scraper assembly to traverse the exterior surface of the quartz sleeve on a pre-determined schedule.

23. The method of claim 22, wherein the pre-determined schedule is every twelve hours or longer.

24. The method of claim 21, further comprising monitoring ultraviolet light intensity through the water treatment system and directing the scraper assembly to traverse the exterior surface of the quartz sleeve responsive to the ultraviolet light intensity being below a threshold value.

25. The method of claim 21, further comprising applying a chemical cleaning process before or concurrently while directing the scraper assembly to traverse the exterior surface of the quartz sleeve.

26. The method of claim 21, wherein the organic material fouling comprises one or more of hardened deposits, sedimentation, oil, grease, and microbiological fouling.

27. The method of claim 26, wherein an amount and/or composition of the organic material fouling is not substantially removable with a rubber scraper.

28. The method of claim 21, comprising operating the water treatment system substantially continuously for at least about six months before replacing the scraper assembly or the ring.
